(19) United States
(12) Patent Application Publication
(10) Pub. No.: US 2022/0180251 A1
(43) Pub. Date: Jun. 9, 2022

(54) SIDELINK-ASSISTED UPDATE AGGREGATION IN FEDERATED LEARNING

(71) Applicant: QUALCOMM Incorporated, San Diego, CA (US)

(72) Inventors: Hamed PEZESHKI, San Diego, CA (US); Tao LUO, San Diego, CA (US); Sony AKKARAKARAN, Poway, CA (US)

(21) Appl. No.: 17/111,470

(22) Filed: Dec. 3, 2020

(51) Int. Cl. G06N 20/20

(52) U.S. Cl. CPC G06N 20/20; H04W 84/042

(57) ABSTRACT

Various aspects of the present disclosure generally relate to wireless communication. In some aspects, a user equipment (UE) may receive a sidelink communication that includes a first local update associated with a machine learning component. The UE may transmit an aggregated local update based at least in part on the first local update associated with the machine learning component and a second local update associated with the machine learning component. Numerous other aspects are provided.

### INTRODUCTION

Aspects of the present disclosure generally relate to wireless communication and to techniques and apparatuses for wireless signaling in federated learning.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication performed by a user equipment (UE) includes receiving a sidelink communication that includes a first local update associated with a machine learning component. The method also may include transmitting an aggregated local update based at least in part on the first local update associated with the machine learning component and a second local update associated with the machine learning component.

In some aspects, a method of wireless communication performed by a first UE includes receiving a machine learning component. The method also may include transmitting a sidelink communication that includes a first local update associated with the machine learning component to a second UE.

In some aspects, a method of wireless communication performed by a base station includes transmitting a machine learning component to a set of user equipment (UEs). The method also may include receiving an aggregated local update that is based at least in part on a first local update associated with the machine learning component and a second local update associated with the machine learning component.

In some aspects, a UE for wireless communication includes a memory and one or more processors coupled to the memory. The memory and the one or more processors may be configured to receive a sidelink communication that includes a first local update associated with a machine learning component. The memory and the one or more processors may be further configured to transmit an aggregated local update based at least in part on the first local update associated with the machine learning component and a second local update associated with the machine learning component.

In some aspects, a first UE for wireless communication includes a memory and one or more processors coupled to the memory. The memory and the one or more processors may be configured to receive a machine learning component. The memory and the one or more processors may be further configured to transmit a sidelink communication that includes a first local update associated with the machine learning component to a second UE.

In some aspects, a base station for wireless communication includes a memory and one or more processors coupled to the memory. The memory and the one or more processors may be configured to transmit a machine learning component to a set of UEs. The memory and the one or more processors may be further configured to receive an aggregated local update that is based at least in part on a first local update associated with the machine learning component and a second local update associated with the machine learning component.

In some aspects, a non-transitory computer-readable medium storing a set of instructions for wireless communication includes one or more instructions that, when executed by one or more processors of a UE, cause the UE to receive a sidelink communication that includes a first local update associated with a machine learning component. The one or more instructions may further cause the UE to transmit an aggregated local update based at least in part on the first local update associated with the machine learning component and a second local update associated with the machine learning component.

In some aspects, a non-transitory computer-readable medium storing a set of instructions for wireless communication includes one or more instructions that, when executed by one or more processors of a first UE, cause the first UE to receive a machine learning component. The one or more instructions may further cause the first UE to transmit a sidelink communication that includes a first local update associated with the machine learning component to a second UE.

In some aspects, a non-transitory computer-readable medium storing a set of instructions for wireless communication includes one or more instructions that, when executed by one or more processors of a base station, cause the base station to transmit a machine learning component to a set of UEs. The one or more instructions may further cause the UE to receive an aggregated local update that is based at least in part on a first local update associated with the machine learning component and a second local update associated with the machine learning component.

In some aspects, an apparatus for wireless communication includes means for receiving a sidelink communication that includes a first local update associated with a machine learning component. The apparatus also may include means for transmitting an aggregated local update based at least in part on the first local update associated with the machine learning component and a second local update associated with the machine learning component.

In some aspects, a first apparatus for wireless communication includes means for receiving a machine learning component. The first apparatus also may include means for transmitting a sidelink communication that includes a first local update associated with the machine learning component to a second apparatus.

In some aspects, an apparatus for wireless communication includes means for transmitting a machine learning component to a set of UEs. The apparatus also may include means for receiving an aggregated local update that is based at least in part on a first local update associated with the machine learning component and a second local update associated with the machine learning component.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of sidelink communications, in accordance with various aspects of the present disclosure.

FIG. 4 is a diagram illustrating an example of sidelink communications and access link communications, in accordance with various aspects of the present disclosure.

FIG. 5 is a diagram illustrating an example of federated learning for machine learning components, in accordance with various aspects of the present disclosure.

FIG. 6 is a diagram illustrating an example associated with sidelink-assisted update aggregation in federated learning, in accordance with various aspects of the present disclosure.

FIG. 7 is a diagram illustrating an example process performed by a UE associated with sidelink-assisted update aggregation in federated learning, in accordance with various aspects of the present disclosure.

FIG. 8 is a diagram illustrating an example process performed by a UE associated with sidelink-assisted update aggregation in federated learning, in accordance with various aspects of the present disclosure.

FIG. 9 is a diagram illustrating an example process performed by a base station associated with sidelink-assisted update aggregation in federated learning, in accordance with various aspects of the present disclosure.

FIGS. 10-12 are block diagrams of example apparatuses for wireless communication at a UE, in accordance with various aspects of the present disclosure.

FIGS. 13-15 are block diagrams of example apparatuses for wireless communication at a base station, in accordance with various aspects of the present disclosure.

### DETAILED DESCRIPTION

Machine learning components are being used more and more to perform a variety of different types of operations. A machine learning component is a software component of a device (e.g., a client device, a server device, a UE, a base station, etc.) that performs one or more machine learning procedures and/or that works with one or more other software and/or hardware components to perform one or more machine learning procedures. In one or more examples, a machine learning component may include, for example, software that may learn to perform a procedure without being explicitly trained to perform the procedure. A machine learning component may include, for example, a feature learning processing block (e.g., a software component that facilitates processing associated with feature learning) and/or a representation learning processing block (e.g., a software component that facilitates processing associated with representation learning). A machine learning component may include one or more neural networks, one or more classifiers, and/or one or more deep learning models, among other examples.

In one or more examples, machine learning components may be distributed in a network. For example, a server device may provide a machine learning component to one or more client devices. The machine learning component may be trained using federated learning. Federated learning is a machine learning technique that enables multiple clients to collaboratively train machine learning components. In federated learning, a client device may use local training data to perform a local training operation associated with the machine learning component. For example, the client device may use local training data to train the machine learning component. Local training data is training data that is generated by, collected by, and/or stored at the client device.

A client device may generate a local update associated with the machine learning component based at least in part on the local training operation. A local update is information associated with the machine learning component that reflects a change to the machine learning component that occurs as a result of the local training operation. For example, a local update may include the locally updated machine learning component (e.g., updated as a result of the local training operation), data indicating one or more aspects (e.g., parameter values, output values, weights) of the locally updated machine learning component, a set of gradients associated with a loss function corresponding to the locally updated machine learning component, a set of parameters (e.g., neural network weights) corresponding to the locally updated machine learning component, and/or the like.

In federated learning, the client device may provide the local update to the server device. The server device may collect local updates from one or more client devices and use those local updates to update a copy of the machine learning component that is maintained at the server device. An update associated with the machine learning component that is maintained at the server device may be referred to as a global update. A global update is information associated with the machine learning component that reflects a change to the machine learning component that occurs based at least in part on one or more local updates and/or a server update. A server update is information associated with the machine learning component that reflects a change to the machine learning component that occurs as a result of a training operation performed by the server device. In one or more examples, a server device may generate a global update by aggregating a number of local updates to generate an aggregated update and applying the aggregated update to the machine learning component.

The server device may provide a global update to the client device or devices. A client device may apply a global update received from a server device to the machine learning component (e.g., to the locally-stored copy of the machine learning component). In this way, a number of client devices may be able to contribute to the training of a machine learning component and a server device may be able to distribute global updates so that each client device maintains a current, updated version of the machine learning component. Federated learning also may facilitate privacy of training data since the server device may generate global updates based on local updates and without collecting training data from client devices.

The exchange of information in this type of federated learning may be done over WiFi connections, where limited and/or costly communication resources are not of concern due to wired connections associated with modems, routers, and/or the like. However, being able to implement federated learning for machine learning components in the cellular context may enable positive impacts in network performance and user experience. In the cellular context, for example, a server device may include, or be included in a base station; and a client device may be, include, or be included in a UE.

Aspects of the techniques and apparatuses described herein may facilitate wireless signaling for federated learning of machine learning components. In one or more aspects, instead of aggregation of all of the local updates being performed by the base station, one or more UEs may assist in aggregating local updates from multiple UEs. For example, a first UE may provide a first local update to a second UE that aggregates the first local update with a second local update. The second local update may be generated by the second UE or provided by a third UE. The second UE may provide the aggregated update to the base station and/or another UE. In this way, one or more aspects may provide aggregation services for UEs that determine that a corresponding uplink channel fails to satisfy a channel quality threshold and/or that power can be saved by transmitting a local update to a UE, and/or the like. As a result, aspects of the techniques and apparatuses described herein may result in positive impacts on network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

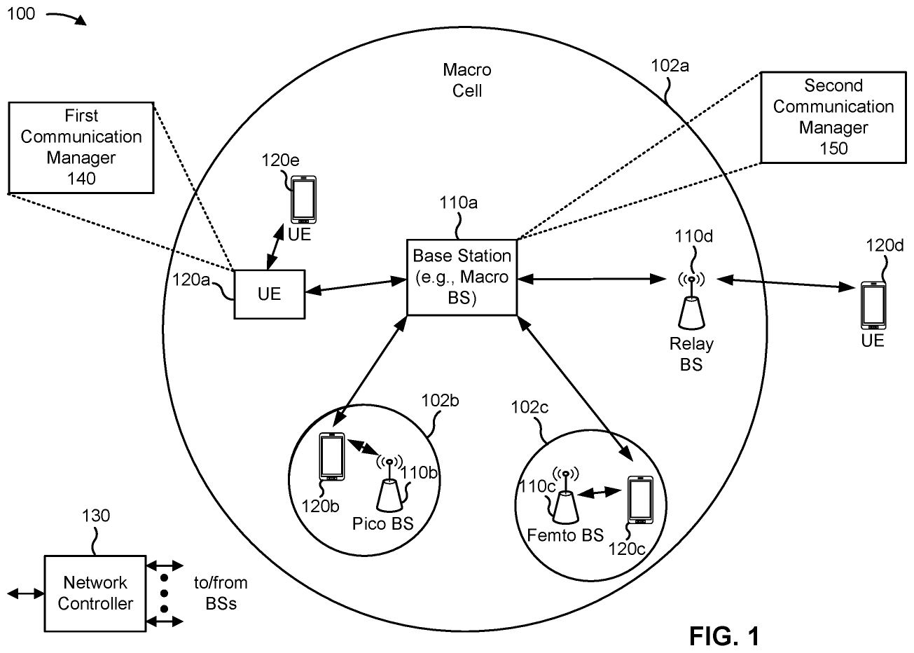

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

In some aspects, the wireless network 100 may include one or more non-terrestrial network (NTN) deployments in which a non-terrestrial wireless communication device may include a UE (referred to herein, interchangeably, as a “non-terrestrial UE”), a BS (referred to herein, interchangeably, as a “non-terrestrial BS” and “non-terrestrial base station”), a relay station (referred to herein, interchangeably, as a “non-terrestrial relay station”), and/or the like. As used herein, “NTN” may refer to a network for which access is facilitated by a non-terrestrial UE, non-terrestrial BS, a non-terrestrial relay station, and/or the like.

The wireless network 100 may include any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of BSs (e.g., stationary and/or ground-based BSs), relay stations, one or more components and/or devices included in a core network of wireless network 100, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul. For example, in some aspects, the wireless network 100 may be, include, or be included in a wireless backhaul network, sometimes referred to as an integrated access and backhaul (IAB) network. In an IAB network, at least one base station (e.g., base station 110) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations, IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 120) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In some aspects, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As shown in FIG. 1, the UE 120 may include a first communication manager 140. As described in more detail elsewhere herein, the first communication manager 140 may receive a sidelink communication that includes a first local update associated with a machine learning component, and transmit an aggregated local update based at least in part on the first local update associated with the machine learning component and a second local update associated with the machine learning component. As described in more detail elsewhere herein, the first communication manager 140 may receive a machine learning component, and transmit a sidelink communication that includes a first local update associated with the machine learning component to a second UE. Additionally, or alternatively, the first communication manager 140 may perform one or more other operations described herein.

In some aspects, the base station 110 may include a second communication manager 150. As described in more detail elsewhere herein, the second communication manager 150 may transmit a machine learning component to a set of UEs, and receive an aggregated local update that is based at least in part on a first local update associated with the machine learning component and a second local update associated with the machine learning component.

Additionally, or alternatively, the second communication manager 150 may perform one or more other operations described herein.

As indicated above, FIG. 1 is provided merely as an example. Other examples may differ from what is described with regard to FIG. 1.

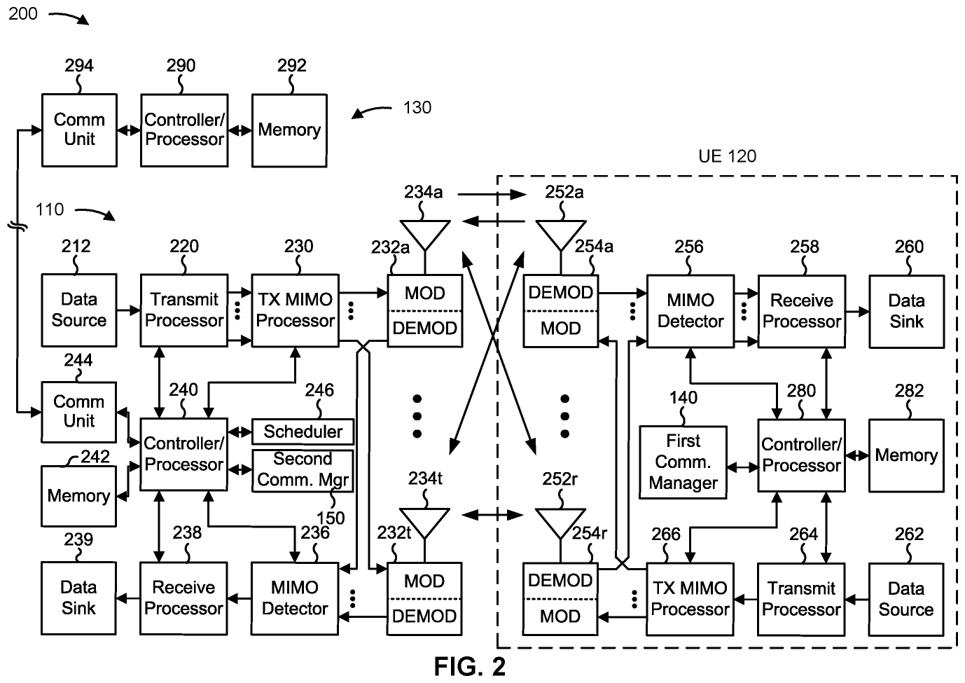

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

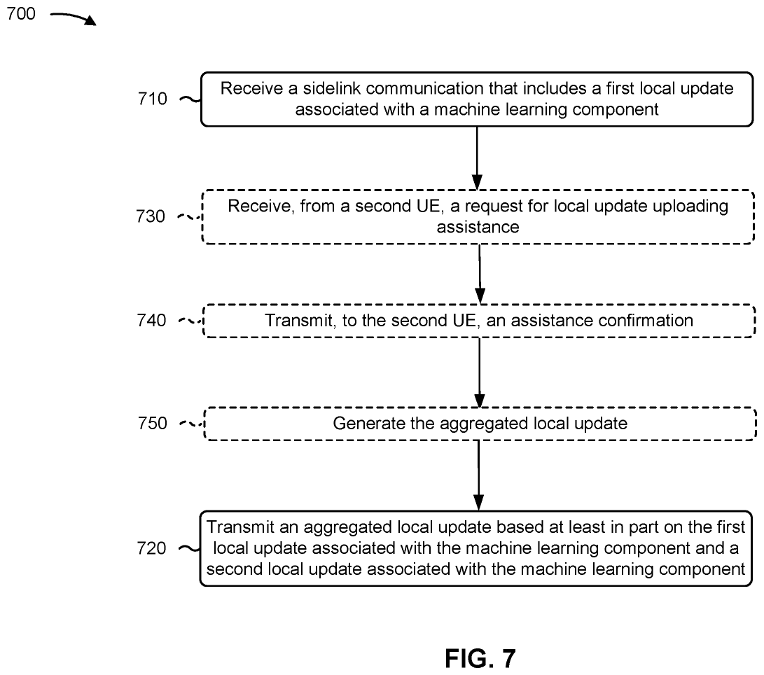

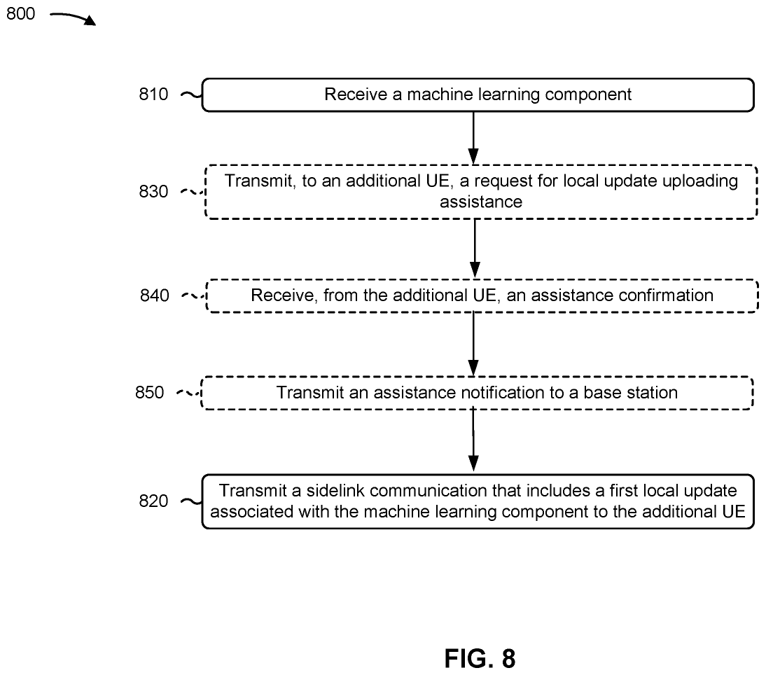

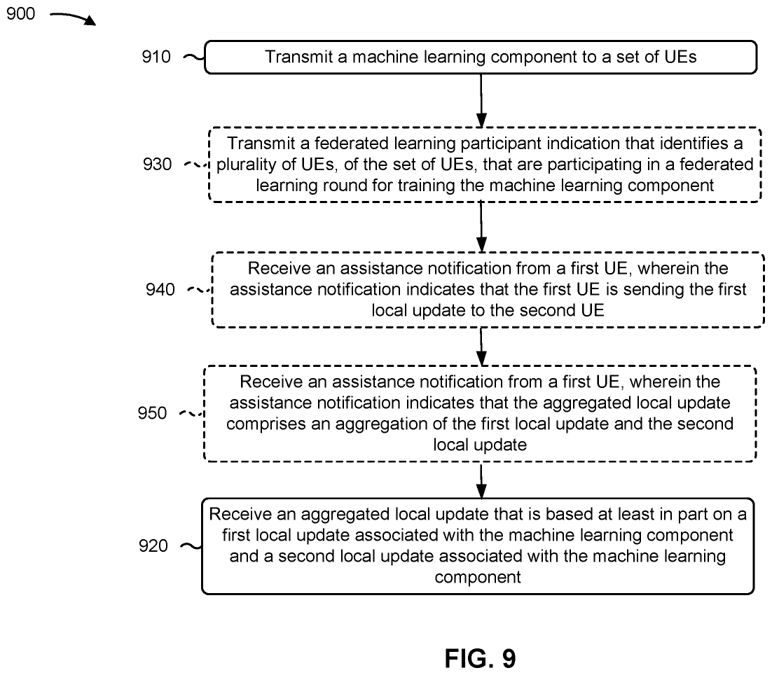

Controller/processor 240 of base station 110, controller/processor 280 of UE 120, and/or any other component(s) of FIG. 2 may perform one or more techniques associated with sidelink-assisted update aggregation in federated learning, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some aspects, executing instructions may include running the instructions, converting the instructions, compiling the instructions, interpreting the instructions, and/or the like.

In some aspects, the UE 120 may include means for receiving a sidelink communication that includes a first local update associated with a machine learning component, means for transmitting an aggregated local update based at least in part on the first local update associated with the machine learning component and a second local update associated with the machine learning component, and/or the like. In some aspects, the UE 120 may include means for receiving a machine learning component, means for transmitting a sidelink communication that includes a first local update associated with the machine learning component to a second UE, and/or the like. Additionally, or alternatively, the UE 120 may include means for performing one or more other operations described herein. In some aspects, such means may include the communication manager 140. Additionally, or alternatively, such means may include one or more other components of the UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, the base station 110 may include means for transmitting a machine learning component to a set of UEs, means for receiving an aggregated local update that is based at least in part on a first local update associated with the machine learning component and a second local update associated with the machine learning component, and/or the like. Additionally, or alternatively, the base station 110 may include means for performing one or more other operations described herein. In some aspects, such means may include the communication manager 150. In some aspects, such means may include one or more other components of the base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided merely as an example. Other examples may differ from what is described with regard to FIG. 2.

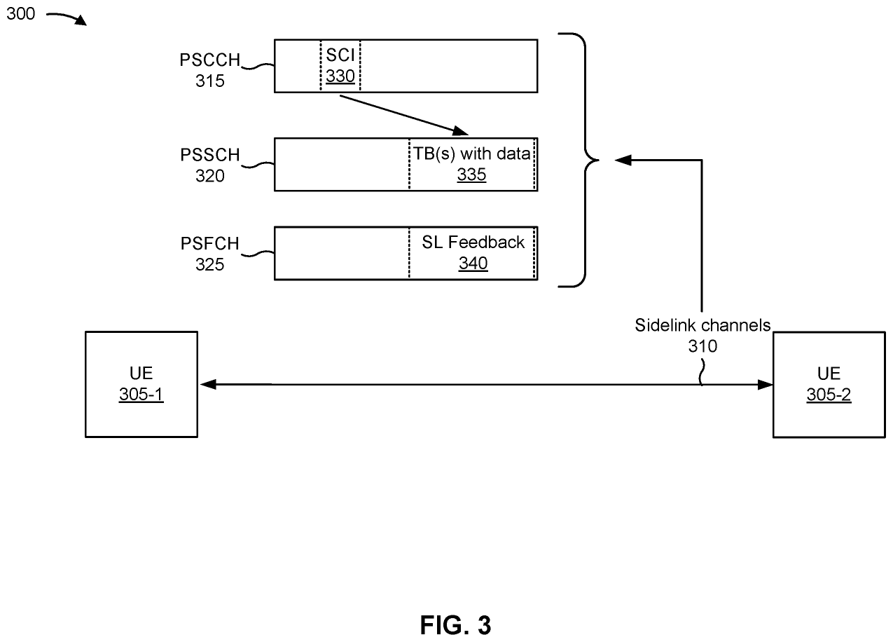

FIG. 3 is a diagram illustrating an example 300 of sidelink communications, in accordance with various aspects of the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, V2P communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARD) feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, a modulation and coding scheme (MCS) to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

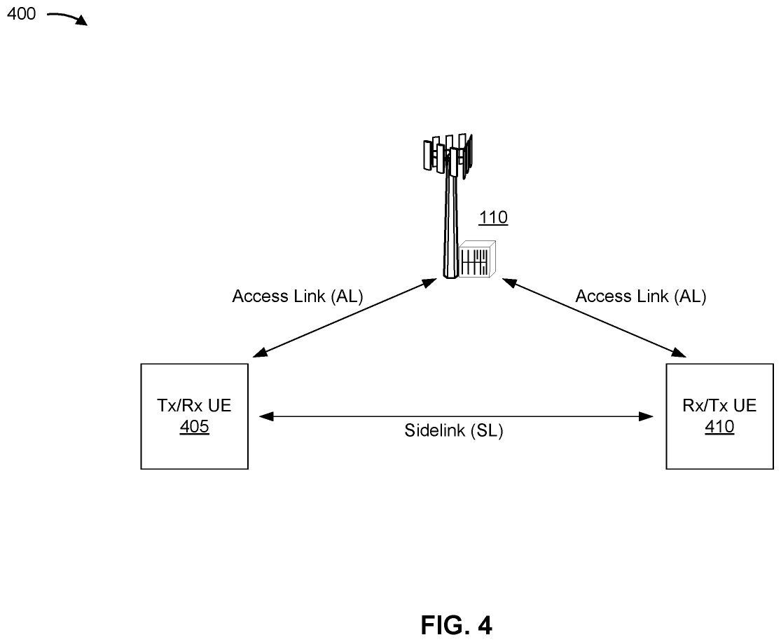

FIG. 4 is a diagram illustrating an example 400 of sidelink communications and access link communications, in accordance with various aspects of the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

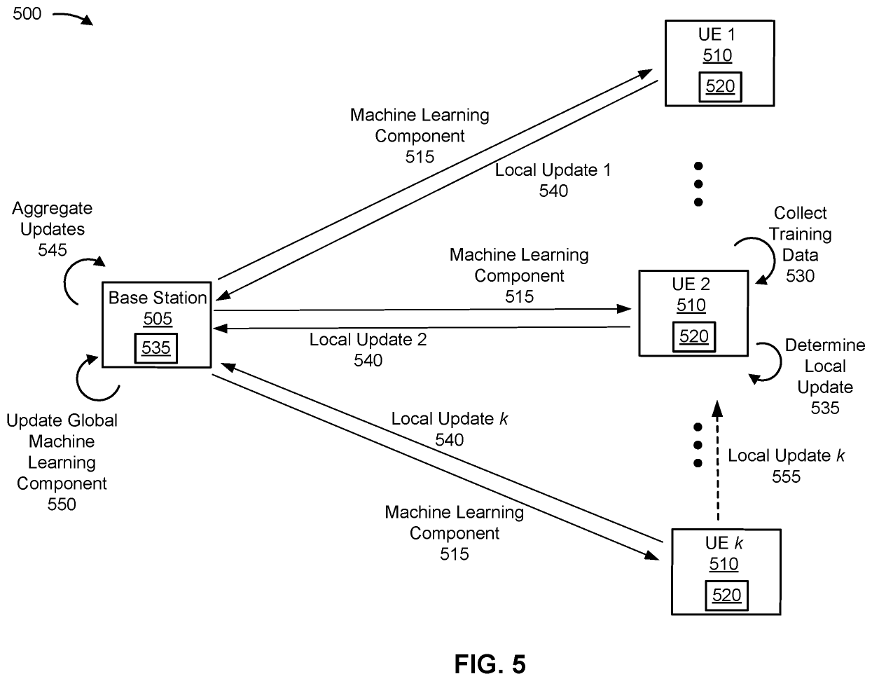

FIG. 5 is a diagram illustrating an example 500 associated with federated learning for machine learning components, in accordance with various aspects of the present disclosure. As shown, a base station 505 may communicate with a set of K UEs 510 (shown as “UE 1, UE 2, . . . , and UE k”). The base station 505 and the UEs 510 may communicate with one another via a wireless network (e.g., the wireless network 100 shown in FIG. 1). In some aspects, any number of additional UEs 510 may be included in the set of K UEs 510. In some aspects, one or more UEs 510 may communicate with one or more other UEs 510 via a sidelink connection.

As shown by reference number 515, the base station 505 may transmit a machine learning component to the UE 1, the UE 2, and the UE k. As shown, the UEs 510 may include a first communication manager 520, which may be, or be similar to, the first communication manager 140 shown in FIG. 1. The first communication manager 520 may be configured to utilize the machine learning component to perform one or more wireless communication tasks and/or one or more user interface tasks. The first communication manager 520 may be configured to utilize any number of additional machine learning components.

As shown in FIG. 5, the base station 505 may include a second communication manager 525, which may be, or be similar to, the second communication manager 150 shown in FIG. 1. The second communication manager 525 may be configured to utilize a global machine learning component to perform one or more wireless communication tasks, to perform one or more user interface tasks, and/or to facilitate federated learning associated with the machine learning component.

The UEs 510 may locally train the machine learning component using training data collected by the UEs, respectively. A UE 510 may train a machine learning component such as a neural network by optimizing a set of model parameters, w⁽ⁿ⁾, associated with the machine learning component, where n is the federated learning round index. The set of UEs 510 may be configured to provide updates to the base station 505 multiple times (e.g., periodically, on demand, upon updating a local machine learning component, etc.).

A federated learning round refers to the training done by a UE 510 that corresponds to an update provided by the UE 510 to the base station 505. In some aspects, “federated learning round” may refer to the transmission by a UE 510, and the reception by the base station 505, of an update. The federated learning round index n indicates the number of the rounds since the last global update was transmitted by the base station 505 to the UE 510. The initial provisioning of a machine learning component on a UE 510, the transmission of a global update to the machine learning component to a UE 510, and/or the like may trigger the beginning of a new round of federated learning.

In some aspects, for example, the first communication manager 520 of the UE 510 may determine an update corresponding to the machine learning component by training the machine learning component. In some aspects, as shown by reference number 530, the UEs 510 may collect training data and store it in a memory device. The stored training data may be referred to as a “local dataset.” As shown by reference number 535, the UEs 510 may determine a local update associated with the machine learning component.

In some aspects, for example, the first communication manager 520 may access training data from the memory device and use the training data to determine an input vector, xⱼ, to be input into the machine learning component to generate a training output, yⱼ, from the machine learning component. The input vector xⱼ may include an array of input values and the training output yⱼ may include a value (e.g., a value between 0 and 9).

The training output yⱼ may be used to facilitate determining the model parameters w⁽ⁿ⁾ that maximize a variational lower bound function. A negative variational lower bound function, which is the negative of the variational lower bound function, may correspond to a local loss function, Fₖ(w), which may be expressed as:

$${F}_{k} ( w ) = \frac{1}{\vert {D}_{k} \vert} {Σ}_{( {x}_{j} , {y}_{j} ) ∈ {D}_{k}} f ( w , {x}_{j} , {y}_{j} ) ,$$

where |Dₖ| is the size of the local dataset Dₖ associated with the UE k. A stochastic gradient descent (SGD) algorithm may be used to optimize the model parameters w⁽ⁿ⁾. The first communication manager 520 may perform one or more SGD procedures to determine the optimized parameters w⁽ⁿ⁾ and may determine the gradients, gₖ⁽ⁿ⁾=∇Fₖ(w⁽ⁿ⁾), of the loss function F(w). The first communication manager 520 may further refine the machine learning component based at least in part on the loss function value, the gradients, and/or the like.

By repeating this process of training the machine learning component to determine the gradients gₖ⁽ⁿ⁾ a number of times, the first communication manager 520 may determine an update corresponding to the machine learning component. Each repetition of the training procedure described above may be referred to as an epoch. In some aspects, the update may include an updated set of model parameters w⁽ⁿ⁾, a difference between the updated set of model parameters w⁽ⁿ⁾ and a prior set of model parameters w⁽ⁿ⁻¹⁾, the set of gradients gₖ⁽ⁿ⁾, an updated machine learning component (e.g., an updated neural network model), and/or the like.

As shown by reference number 540, the UEs 510 may transmit their respective local updates (shown as “local update 1, local update 2, . . . , local update k”). In some aspects, the local update may include a compressed version of a local update. For example, in some aspects, a UE 510 may transmit a compressed set of gradients, \tilde{g}ₖ⁽ⁿ⁾=q(gₖ⁽ⁿ⁾), where q represents a compression scheme applied to the set of gradients gₖ⁽ⁿ⁾.

A “round” may refer to the process of generating a local update and providing the local update to the base station 505. In some aspects, a “round” may refer to the training, generation and uploading of local updates by all of the UEs in a set of UEs participating in a federated learning procedure. The round may include the procedure described below in which the base station 505 aggregates the local updates and determines a global update based at least in part on the aggregated local updates. In some aspects, the round may include transmitting the global update to the UEs 510. In aspects, a round may include any number of epochs performed by one or more UEs 510.

As shown by reference number 545, the base station 510 (e.g., using the second communication manager 525) may aggregate the updates received from the UEs 510. For example, the second communication manager 525 may average the received gradients to determine an aggregated update, which may be expressed as

$${g}^{( n )} = \frac{1}{K} {\sum }_{k = 1}^{K} {\tilde{g}}_{k}^{( n )} ,$$

where, as explained above, K is the total number of UEs 510 from which updates were received. In some examples, the second communication manager 525 may aggregate the received updates using any number of other aggregation techniques. As shown by reference number 550, the second communication manager 525 may update the global machine learning component based on the aggregated updates. In some aspects, for example, the second communication manager 525 may update the global machine learning component by normalizing the local datasets by treating each dataset size, |Dₖ|, as being equal. The second communication manager 525 may update the global machine learning component using multiple rounds of updates from the UEs 510 until a global loss function is minimized. The global loss function may be given, for example, by:

$$F ( w ) = \frac{{Σ}_{k = 1}^{K} {Σ}_{j ∈ {D}_{k}} {f}_{j} ( w )}{K * D} = \frac{1}{K} {Σ}_{k = 1}^{K} {F}_{k} ( w ) ,$$

where |Dₖ|=D, and where D is a normalized constant. In some aspects, the base station 505 may transmit an update associated with the updated global machine learning component to the UEs 510.

As explained above, updating the global machine learning component includes aggregating local updates from a number of UEs. However, leveraging sidelink communications between UEs to facilitate local update aggregation and/or transmission to the base station may enable positive impacts in network performance. Aspects of the techniques and apparatuses described herein may facilitate sidelink-assisted update aggregation in federated learning.

In some aspects, as shown by reference number 555, a UE k 510 may transmit the local update k that it generates to another UE 2 510. The UE 2 510 may generate an aggregated local update by aggregating the local update k and a local update determined by the UE 2 510. In some aspects, the UE 2 510 may aggregate the updates by averaging them. In some aspects, the UE 2 510 may generate the aggregated local update by summing the updates, including the updates together without performing a mathematical operation on them, and/or the like. Thus, in some aspects, the local update 2 may include an aggregated local update. In some aspects, the UE 2 510 may transmit the aggregated local update to another UE 510 (e.g., UE 1), which may aggregate the aggregated local update with a local update generated by that UE 510 to generate an additional aggregated local update. The additional aggregated local update may be transmitted to the base station 505 and/or another UE 510.

In this way, one or more UEs 510 may assist in aggregating local updates, provide aggregation services for UEs 510 that determine that a corresponding uplink channel fails to satisfy a channel quality threshold, that determine that power can be saved by transmitting a local update to a UE, and/or the like. As a result, aspects of the techniques and apparatuses described herein may result in positive impacts on network performance. As local datasets associated with the UEs 510 are not exchanged, transmission of local updates between UEs 510 may not adversely impact UE privacy.

As indicated above, FIG. 5 is provided merely as an example. Other examples may differ from what is described with regard to FIG. 5.

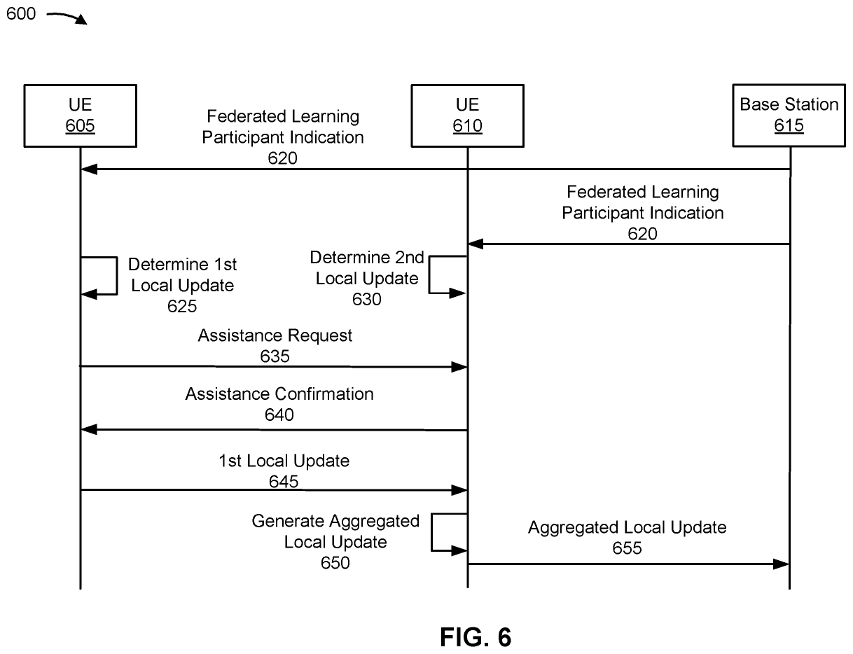

FIG. 6 is a diagram illustrating an example 600 of machine learning component management in federated learning, in accordance with various aspects of the present disclosure. As shown, a UE 605, a UE 610, and a base station 615 may communicate with one another. In some aspects, the UE 605 and/or the UE 610 may be, be similar to, include, or be included in one or more of the UEs 510 shown in FIG. 5. In some aspects, the base station 410 may be, be similar to, include, or be included in the base station 505 shown in FIG. 5. In some aspects, the UEs 605 and 610 may communicate with one another via a sidelink connection. The UEs 605 and/or 610 may communicate with the base station 615 via an access link.

As shown by reference number 620, the base station 610 may transmit, and the UE 605 may receive, a federated learning participant indication. The UE 610 also may receive the federated learning participant indication. The federated learning participant indication may identify one or more UEs of a set of UEs participating in a federated learning round. For example, the federated learning participant indication may identify the UE 605 and the UE 610. The federated learning participant indication may be multicast to the UEs of the set of participating UEs.

As shown by reference number 625, the UE 605 may determine a first local update associated with the machine learning component based at least in part on training data collected by the UE 605 (e.g., using a process similar to that described above in connection with FIG. 5). As shown by reference number 630, the UE 610 may determine a second local update associated with the machine learning component based at least in part on training data collected by the UE 610. The first and/or second local updates may include at least one gradient of a respective loss function associated with the machine learning component.

As shown by reference number 635, the UE 605 may transmit, and the UE 610 may receive, a request for local update uploading assistance (shown as an “assistance request”). The UE 605 may transmit the request via a sidelink connection. In some aspects, the request may include a request to forward the first local update to the base station 615 either directly or via another UE. In some aspects, the request may include a request to perform an aggregation of the first local update and the second local update. As shown by reference number 640, the UE 610 may transmit, and the UE 605 may receive, an assistance confirmation. In some aspects, this initial request and confirmation exchange may be used to avoid the case in which the UE 610 had already sent the second local update to the base station 615.

As shown by reference number 645, the UE 605 may transmit, and the UE 610 may receive, the first local update. The UE 605 may transmit the first local update by transmitting a sidelink communication that includes the first local update. In some aspects, the UE 605 may transmit the sidelink communication to the UE 610 based at least in part on receiving the assistance confirmation. In some aspects, the sidelink communication may be carried on at least one of a physical sidelink control channel (PSCCH), a physical sidelink shared channel (PSSCH), or a combination thereof. In some aspects, the UE 605 may transmit an assistance notification to the base station 615 that indicates that the UE 605 is sending the first local update to the UE 610. In some aspects, the assistance notification may indicate an identifier associated with the UE 610.

The UE 605 may transmit the first local update to the UE 610 in any number of different scenarios. For example, the UE 605 may determine that a channel quality associated with an uplink channel between the UE 605, and the base station 615 fails to satisfy a quality threshold. The UE 605 may transmit the sidelink communication based at least in part on determining that the channel quality associated with the uplink channel fails to satisfy a quality threshold. In some aspects, the UE 605 may save power by transmitting the first local update to the UE 610, rather than transmitting the first local update over an uplink channel to the base station 615.

As shown by reference number 650, the UE 610 may generate an aggregated local update. In some aspects, the UE 610 may generate the aggregated local update by aggregating the first local update and the second local update. In some aspects, the UE 610 may aggregate any number of other local updates. The UE 610 may aggregate the local updates by averaging the first local update with the second local update, summing the first local update and the second local update, including the first local update with the second local update, and/or the like. In some aspects, the first local update may include compressed local update information (e.g., compressed gradients and/or the like), and the UE 610 may compress second local update information to generate compressed second local update information. The UE 610 may aggregate the compressed first local update information and the compressed second local update information to generate the aggregated update. In some aspects, the first local update may include an additional aggregated update (e.g., an aggregation of a local update associated with the UE 605 and another local update associated with another UE), and the UE 610 may generate the aggregated update by aggregating the additional aggregated local update and the second local update.

As shown by reference number 655, the UE 610 may transmit the aggregated local update to the base station 615. In some aspects, the UE 610 may transmit the aggregated local update to another UE (not shown). The UE 610 may transmit an assistance notification to the base station 615 that indicates that the aggregated update comprises an aggregation of the first local update and the second local update. In some aspects, the assistance notification may indicate a first identifier associated with the UE 605 and a second identifier associated with the UE 610.

As indicated above, FIG. 6 is provided merely as an example. Other examples may differ from what is described with regard to FIG. 6.

FIG. 7 is a diagram illustrating an example process 700 performed, for example, by a first UE, in accordance with various aspects of the present disclosure. Example process 700 is an example where the UE (e.g., UE 610) performs operations associated with sidelink-assisted update aggregation in federated learning.

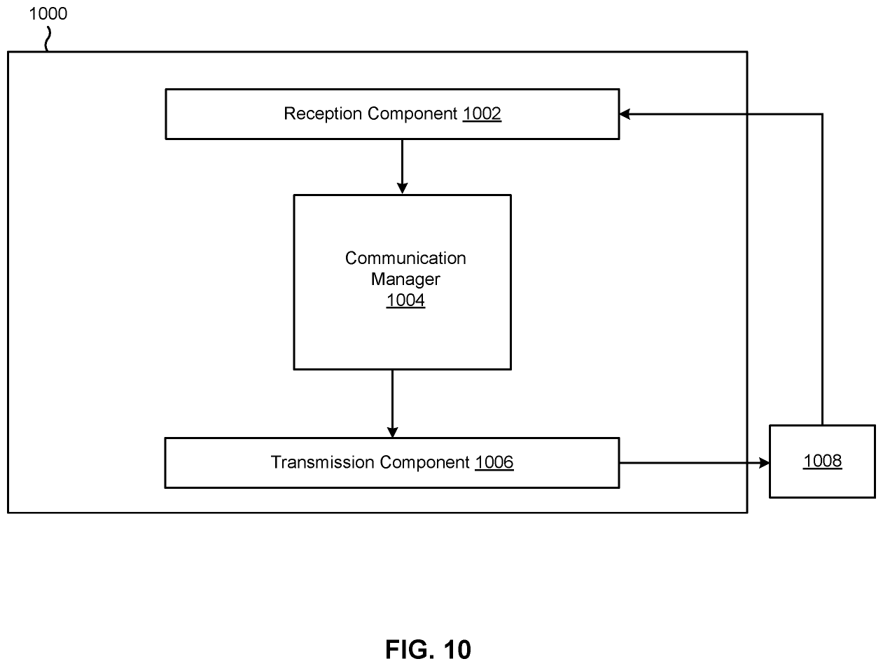

As shown in FIG. 7, in some aspects, process 700 may include receiving a sidelink communication that includes a first local update associated with a machine learning component (block 710). For example, the UE (e.g., using reception component 1002, depicted in FIG. 10) may receive a sidelink communication that includes a first local update associated with a machine learning component, as described above.

As further shown in FIG. 7, in some aspects, process 700 may include transmitting an aggregated local update based at least in part on the first local update associated with the machine learning component and a second local update associated with the machine learning component (block 720). For example, the UE (e.g., using transmission component 1006, depicted in FIG. 10) may transmit an aggregated local update based at least in part on the first local update associated with the machine learning component and a second local update associated with the machine learning component, as described above.

Process 700 may include additional aspects, such as any single aspect or any combination of aspects described below and/or in connection with one or more other processes described elsewhere herein.

In a first aspect, process 700 includes determining the second local update associated with the machine learning component based at least in part on training the machine learning component.

In a second aspect, receiving the sidelink communication that includes the first local update comprises receiving the sidelink communication from a second UE, and process 700 includes receiving the second local update from a third UE.

In a third aspect, alone or in combination with one or more of the first and second aspects, process 700 includes receiving, from a second UE, a request for local update uploading assistance (block 730), and transmitting, to the second UE, an assistance confirmation (block 740), wherein receiving the sidelink communication that includes the first local update comprises receiving the first local update based at least in part on transmitting the assistance confirmation.

In a fourth aspect, alone or in combination with the third aspect, the request comprises a request to perform an aggregation of the first local update and the second local update.

In a fifth aspect, alone or in combination with one or more of the first through fourth aspects, the first local update comprises compressed first local update information.

In a sixth aspect, alone or in combination with the fifth aspect, process 700 includes compressing second local update information to generate compressed second local update information, and aggregating the compressed first local update information and the compressed second local update information to generate the aggregated local update.

In a seventh aspect, alone or in combination with one or more of the first through sixth aspects, process 700 includes generating the aggregated local update by aggregating the first local update and the second local update (block 750), wherein aggregating the first local update and the second local update comprises averaging the first local update and the second local update.

In an eighth aspect, alone or in combination with one or more of the first through seventh aspects, transmitting the aggregated local update comprises transmitting the aggregated local update to a base station, and process 700 includes transmitting an assistance notification to the base station, wherein the assistance notification indicates that the aggregated local update comprises an aggregation of the first local update and the second local update.

In a ninth aspect, alone or in combination with the eighth aspect, the assistance notification indicates an identifier associated with a second UE.

In a tenth aspect, alone or in combination with one or more of the first through seventh aspects, transmitting the aggregated local update comprises transmitting the aggregated local update to a third UE.

In an eleventh aspect, alone or in combination with one or more of the first through tenth aspects, the first local update comprises an additional aggregated local update.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with various aspects of the present disclosure. Example process 800 is an example where the UE (e.g., UE 605) performs operations associated with sidelink-assisted update aggregation in federated learning.

As shown in FIG. 8, in some aspects, process 800 may include receiving a machine learning component (block 810). For example, the UE (e.g., using reception component 1002, depicted in FIG. 10) may receive a machine learning component, as described above.

As further shown in FIG. 8, in some aspects, process 800 may include transmitting a sidelink communication that includes a first local update associated with the machine learning component to an additional UE (block 820). For example, the UE (e.g., using transmission component 1006, depicted in FIG. 10) may transmit a sidelink communication that includes a first local update associated with the machine learning component to an additional UE, as described above.

Process 800 may include additional aspects, such as any single aspect or any combination of aspects described below and/or in connection with one or more other processes described elsewhere herein.

In a first aspect, process 800 includes receiving a federated learning participant indication that identifies the additional UE as a UE that is participating in a federated learning round for training the machine learning component.

In a second aspect, alone or in combination with the first aspect, process 800 includes transmitting, to the additional UE, a request for local update uploading assistance (block 730), and receiving, from the additional UE, an assistance confirmation (block 740), wherein transmitting the sidelink communication to the additional UE comprises transmitting the sidelink communication based at least in part on receiving the assistance confirmation.

In a third aspect, alone or in combination with the second aspect, the request comprises a request to perform an aggregation of the first local update and a second local update, wherein the second local update is generated by the additional UE.

In a fourth aspect, alone or in combination with one or more of the first through third aspects, the first local update comprises at least one gradient of a loss function associated with the machine learning component.

In a fifth aspect, alone or in combination with one or more of the first through fourth aspects, the first local update comprises compressed local update information.

In a sixth aspect, alone or in combination with one or more of the first through fifth aspects, process 800 includes transmitting an assistance notification to a base station (block 750), wherein the assistance notification indicates that the first UE is sending the first local update to the additional UE.

In a seventh aspect, alone or in combination with the sixth aspect, the assistance notification indicates an identifier associated with the additional UE.

In an eighth aspect, alone or in combination with one or more of the first through seventh aspects, process 800 includes determining that a channel quality associated with an uplink channel fails to satisfy a quality threshold, wherein transmitting the sidelink communication comprises transmitting the sidelink communication based at least in part on determining that the channel quality associated with the uplink channel fails to satisfy a quality threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with various aspects of the present disclosure. Example process 900 is an example where the base station (e.g., base station 110) performs operations associated with sidelink-assisted update aggregation in federated learning.

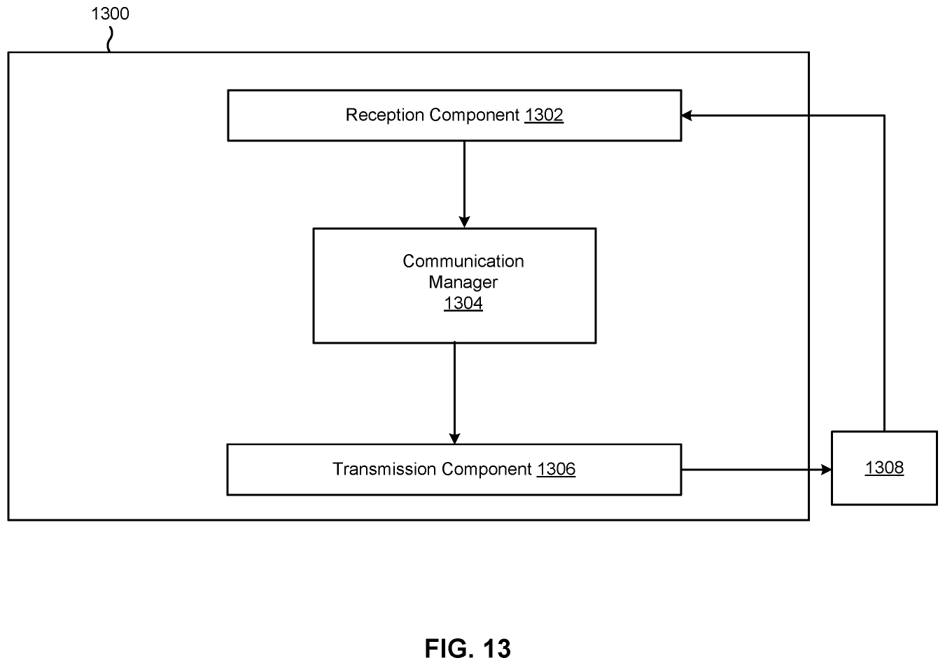

As shown in FIG. 9, in some aspects, process 900 may include transmitting a machine learning component to a set of UEs (block 910). For example, the base station (e.g., using transmission component 1306, depicted in FIG. 13) may transmit a machine learning component to a set of UEs, as described above.

As further shown in FIG. 9, in some aspects, process 900 may include receiving an aggregated local update that is based at least in part on a first local update associated with the machine learning component and a second local update associated with the machine learning component (block 920). For example, the base station (e.g., using reception component 1302, depicted in FIG. 13) may receive an aggregated local update that is based at least in part on a first local update associated with the machine learning component and a second local update associated with the machine learning component, as described above.

Process 900 may include additional aspects, such as any single aspect or any combination of aspects described below and/or in connection with one or more other processes described elsewhere herein.

In a first aspect, process 900 includes transmitting a federated learning participant indication that identifies a plurality of UEs, of the set of UEs, that are participating in a federated learning round for training the machine learning component (block 930).

In a second aspect, alone or in combination with the first aspect, process 900 includes receiving an assistance notification from a first UE, wherein the assistance notification indicates that the first UE is sending the first local update to the second UE (block 940).

In a third aspect, alone or in combination with the second aspect, the assistance notification indicates an identifier associated with the second UE.

In a fourth aspect, alone or in combination with one or more of the first through third aspects, process 900 includes receiving an assistance notification from a first UE, wherein the assistance notification indicates that the aggregated local update comprises an aggregation of the first local update and the second local update (block 950).

In a fifth aspect, alone or in combination with the fourth aspect, the first local update corresponds to the first UE and the second local update corresponds to the second UE.

In a sixth aspect, alone or in combination with one or more of the first through fifth aspects, the assistance notification indicates a first identifier associated with the first UE and a second identifier associated with the second UE.

In a seventh aspect, alone or in combination with one or more of the first through sixth aspects, the aggregated local update comprises compressed aggregated local update information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication in accordance with various aspects of the present disclosure. The apparatus 1000 may be, be similar to, include, or be included in a UE (e.g., UE 605 and/or UE 610 shown in FIG. 6). In some aspects, the apparatus 1000 includes a reception component 1002, a communication manager 1004, and a transmission component 1006, which may be in communication with one another (for example, via one or more buses). As shown, the apparatus 1000 may communicate with another apparatus 1008 (such as a client, a server, a UE, a base station, or another wireless communication device) using the reception component 1002 and the transmission component 1006.

In some aspects, the apparatus 1000 may be configured to perform one or more operations described herein in connection with FIGS. 5 and/or 6. Additionally, or alternatively, the apparatus 1000 may be configured to perform one or more processes described herein, such as process 700 of FIG. 7, process 800 of FIG. 8, among other processes. In some aspects, the apparatus 1000 may include one or more components of the first UE described above in connection with FIG. 2.

The reception component 1002 may provide means for receiving communications, such as reference signals, control information, data communications, or a combination thereof, from the apparatus 1008. The reception component 1002 may provide received communications to one or more other components of the apparatus 1000, such as the communication manager 1004. In some aspects, the reception component 1002 may provide means for signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a demodulator, a MIMO detector, a receive processor, a controller/processor, a memory, or a combination thereof, of the first UE described above in connection with FIG. 2.

The transmission component 1006 may provide means for transmitting communications, such as reference signals, control information, data communications, or a combination thereof, to the apparatus 1008. In some aspects, the communication manager 1004 may generate communications and may transmit the generated communications to the transmission component 1006 for transmission to the apparatus 1008. In some aspects, the transmission component 1006 may provide means for performing signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1006 may include one or more antennas, a modulator, a transmit MIMO processor, a transmit processor, a controller/processor, a memory, or a combination thereof, of the first UE described above in connection with FIG. 2. In some aspects, the transmission component 1006 may be co-located with the reception component 1002 in a transceiver.

In some aspects, the communication manager 1004 may provide means for receiving a sidelink communication that includes a first local update associated with a machine learning component; and transmitting an aggregated local update based at least in part on the first local update associated with the machine learning component and a second local update associated with the machine learning component. In some aspects, the communication manager 1004 may provide means for receiving a machine learning component; and transmitting a sidelink communication that includes a first local update associated with the machine learning component to an additional UE. In some aspects, the communication manager 1004 may include a controller/processor, a memory, or a combination thereof, of the first UE described above in connection with FIG. 2. In some aspects, the communication manager 1004 may include the reception component 1002, the transmission component 1006, and/or the like. In some aspects, the means provided by the communication manager 1004 may include, or be included within, means provided by the reception component 1002, the transmission component 1004, and/or the like.

In some aspects, the communication manager 1004 and/or one or more components of the communication manager 1004 may include or may be implemented within hardware (e.g., one or more of the circuitry described in connection with FIG. 2). In some aspects, the communication manager 1004 and/or one or more components thereof may include or may be implemented within a controller/processor, a memory, or a combination thereof, of the UE 120 described above in connection with FIG. 2.

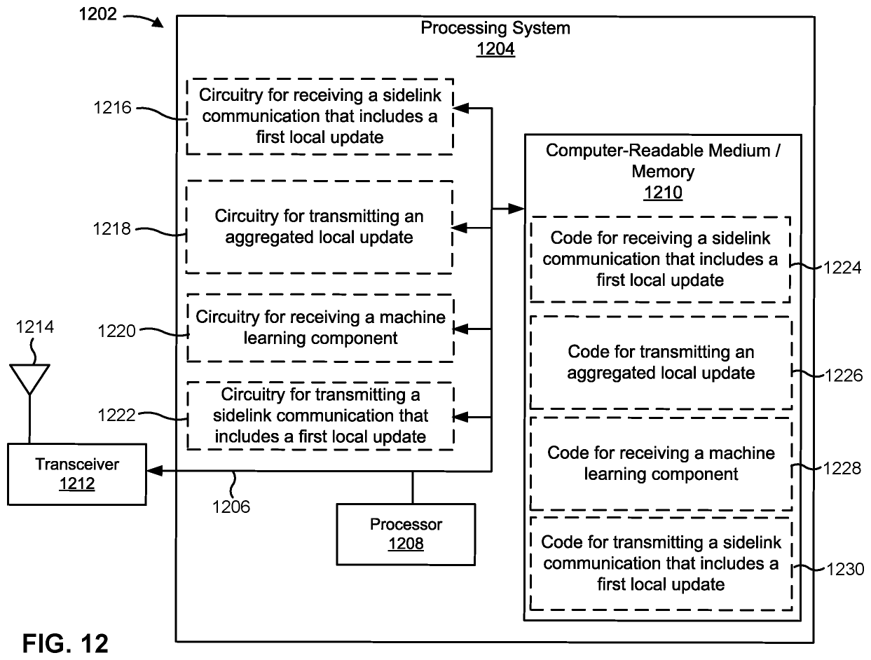

In some aspects, the communication manager 1004 and/or one or more components of the communication manager 1004 may be implemented in code (e.g., as software or firmware stored in a memory), such as the code described in connection with FIG. 12. For example, the communication manager 1004 and/or a component (or a portion of a component) of the communication manager 1004 may be implemented as instructions or code stored in a non-transitory computer-readable medium and executable by a controller or a processor to perform the functions or operations of the communication manager 1004 and/or the component. If implemented in code, the functions of the communication manager 1004 and/or a component may be executed by a controller/processor, a memory, a scheduler, a communication unit, or a combination thereof, of the UE 120 described above in connection with FIG. 2.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

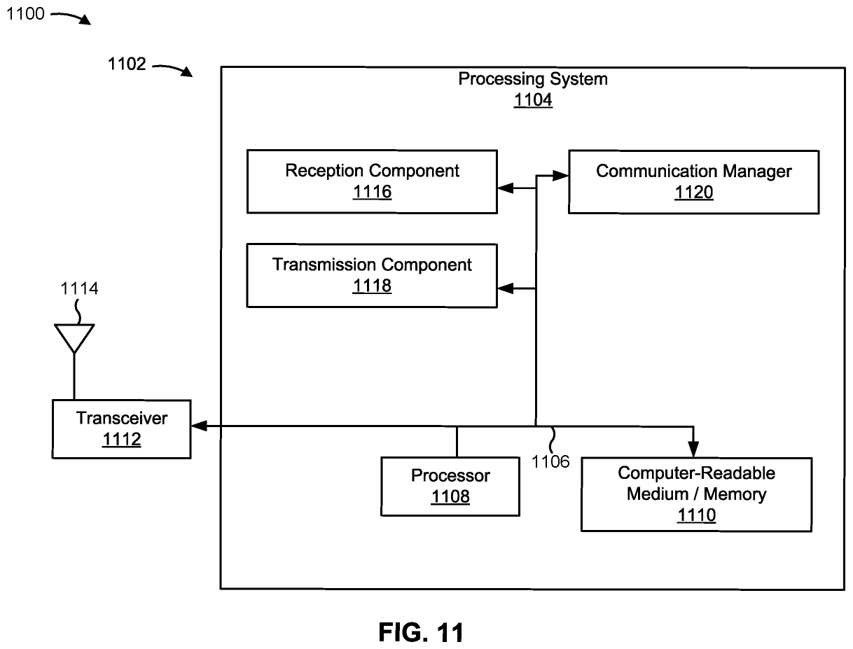

FIG. 11 is a diagram illustrating an example 1100 of a hardware implementation for an apparatus 1102 employing a processing system 1104. The apparatus 1102 may be, be similar to, include, or be included in the apparatus 1000 shown in FIG. 10.

The processing system 1104 may be implemented with a bus architecture, represented generally by the bus 1106. The bus 1106 may include any number of interconnecting buses and bridges depending on the specific application of the processing system 1104 and the overall design constraints. The bus 1106 links together various circuits including one or more processors and/or hardware components, represented by a processor 1108, the illustrated components, and the computer-readable medium/memory 1110. The bus 1106 may also link various other circuits, such as timing sources, peripherals, voltage regulators, power management circuits, and/or the like.

The processing system 1104 may be coupled to a transceiver 1112. The transceiver 1112 is coupled to one or more antennas 1114. The transceiver 1112 provides a means for communicating with various other apparatuses over a transmission medium. The transceiver 1112 receives a signal from the one or more antennas 1114, extracts information from the received signal, and provides the extracted information to the processing system 1104, specifically a reception component 1116. In addition, the transceiver 1112 receives information from the processing system 1104, specifically a transmission component 1118, and generates a signal to be applied to the one or more antennas 1114 based at least in part on the received information.

The processor 1108 is coupled to the computer-readable medium/memory 1110. The processor 1108 is responsible for general processing, including the execution of software stored on the computer-readable medium/memory 1110. The software, when executed by the processor 1108, causes the processing system 1104 to perform the various functions described herein in connection with a client. The computer-readable medium/memory 1110 may also be used for storing data that is manipulated by the processor 1108 when executing software. The processing system 1104 may include any number of additional components not illustrated in FIG. 11. The components illustrated and/or not illustrated may be software modules running in the processor 1108, resident/stored in the computer readable medium/memory 1110, one or more hardware modules coupled to the processor 1108, or some combination thereof.

In some aspects, the processing system 1104 may be a component of the UE 120 and may include the memory 282 and/or at least one of the TX MIMO processor 266, the RX processor 258, and/or the controller/processor 280. In some aspects, the apparatus 1102 for wireless communication provides means for receiving a sidelink communication that includes a first local update associated with a machine learning component; and transmitting an aggregated local update based at least in part on the first local update associated with the machine learning component and a second local update associated with the machine learning component. In some aspects, the apparatus 1102 for wireless communication provides means for receiving a machine learning component; and transmitting a sidelink communication that includes a first local update associated with the machine learning component to an additional UE. The aforementioned means may be one or more of the aforementioned components of the processing system 1104 of the apparatus 1102 configured to perform the functions recited by the aforementioned means. As described elsewhere herein, the processing system 1104 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

FIG. 12 is a diagram illustrating an example 1200 of an implementation of code and circuitry for an apparatus 1202 for wireless communication. The apparatus 1202 may be, be similar to, include, or be included in the apparatus 1000 shown in FIG. 10 and/or the apparatus 1102 shown in FIG. 11. The apparatus 1202 may include a processing system 1204, which may include a bus 1206 coupling one or more components such as, for example, a processor 1208, computer-readable medium/memory 1210, a transceiver 1212, and/or the like. As shown, the transceiver 1212 may be coupled to one or more antenna 1214.

As further shown in FIG. 12, the apparatus 1202 may include circuitry for receiving a sidelink communication that includes a first local update associated with a machine learning component (circuitry 1216). For example, the apparatus 1202 may include circuitry 1216 to enable the apparatus 1202 to receive a sidelink communication that includes a first local update associated with a machine learning component.

As further shown in FIG. 12, the apparatus 1202 may include circuitry for transmitting an aggregated local update based at least in part on the first local update associated with the machine learning component and a second local update associated with the machine learning component (circuitry 1218). For example, the apparatus 1202 may include circuitry 1218 to enable the apparatus 1202 to transmit an aggregated local update based at least in part on the first local update associated with the machine learning component and a second local update associated with the machine learning component.

As further shown in FIG. 12, the apparatus 1202 may include circuitry for receiving a machine learning component (circuitry 1220). For example, the apparatus 1202 may include circuitry 1220 to enable the apparatus 1202 to receive a machine learning component.

As further shown in FIG. 12, the apparatus 1202 may include circuitry for transmitting a sidelink communication that includes a first local update associated with the machine learning component to an additional UE (circuitry 1222). For example, the apparatus 1202 may include circuitry 1222 to enable the apparatus 1202 to transmit a sidelink communication that includes a first local update associated with the machine learning component to an additional UE.

As further shown in FIG. 12, the apparatus 1202 may include, stored in computer-readable medium 1210, code for receiving a sidelink communication that includes a first local update associated with a machine learning component (code 1224). For example, the apparatus 1202 may include code 1224 that, when executed by the processor 1208, may cause the transceiver 1212 to receive a sidelink communication that includes a first local update associated with a machine learning component.

As further shown in FIG. 12, the apparatus 1202 may include, stored in computer-readable medium 1210, code for transmitting an aggregated local update based at least in part on the first local update associated with the machine learning component and a second local update associated with the machine learning component (code 1226). For example, the apparatus 1202 may include code 1226 that, when executed by the processor 1208, may cause the transceiver 1212 to transmit an aggregated local update based at least in part on the first local update associated with the machine learning component and a second local update associated with the machine learning component.

As further shown in FIG. 12, the apparatus 1202 may include, stored in computer-readable medium 1210, code for receiving a machine learning component (code 1228). For example, the apparatus 1202 may include code 1228 that, when executed by the processor 1208, may cause the transceiver 1212 to receive a machine learning component.

As further shown in FIG. 12, the apparatus 1202 may include, stored in computer-readable medium 1210, code for transmitting a sidelink communication that includes a first local update associated with the machine learning component to a second UE (code 1230). For example, the apparatus 1202 may include code 1230 that, when executed by the processor 1208, may cause the transceiver 1212 to transmit a sidelink communication that includes a first local update associated with the machine learning component to an additional UE.

FIG. 12 is provided as an example. Other examples may differ from what is described in connection with FIG. 12.

FIG. 13 is a block diagram of an example apparatus 1300 for wireless communication in accordance with various aspects of the present disclosure. The apparatus 1300 may be, be similar to, include, or be included in a base station (e.g., base station 615 shown in FIG. 6). In some aspects, the apparatus 1300 includes a reception component 1302, a communication manager 1304, and a transmission component 1306, which may be in communication with one another (for example, via one or more buses). As shown, the apparatus 1300 may communicate with another apparatus 1308 (such as a client, a server, a UE, a base station, or another wireless communication device) using the reception component 1302 and the transmission component 1306.

In some aspects, the apparatus 1300 may be configured to perform one or more operations described herein in connection with FIGS. 5 and/or 6. Additionally, or alternatively, the apparatus 1300 may be configured to perform one or more processes described herein, such as process 900 of FIG. 9. In some aspects, the apparatus 1300 may include one or more components of the base station described above in connection with FIG. 2.

The reception component 1302 may provide means for receiving communications, such as reference signals, control information, data communications, or a combination thereof, from the apparatus 1308. The reception component 1302 may provide received communications to one or more other components of the apparatus 1300, such as the communication manager 1304. In some aspects, the reception component 1302 may provide means for performing signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a demodulator, a MIMO detector, a receive processor, a controller/processor, a memory, or a combination thereof, of the base station described above in connection with FIG. 2.

The transmission component 1306 may provide means for transmitting communications, such as reference signals, control information, data communications, or a combination thereof, to the apparatus 1308. In some aspects, the communication manager 1304 may generate communications and may transmit the generated communications to the transmission component 1306 for transmission to the apparatus 1308. In some aspects, the transmission component 1306 may provide means for performing signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1306 may include one or more antennas, a modulator, a transmit MIMO processor, a transmit processor, a controller/processor, a memory, or a combination thereof, of the base station described above in connection with FIG. 2. In some aspects, the transmission component 1306 may be co-located with the reception component 1302 in a transceiver.

The communication manager 1304 may provide means for transmitting a federated learning participant indication that identifies a plurality of UEs that are participating in a federated learning round for training a machine learning component; and means for receiving an aggregated update that is based at least in part on a first local update associated with the machine learning component and a second local update associated with the machine learning component. In some aspects, the communication manager 1304 may include a controller/processor, a memory, a scheduler, a communication unit, or a combination thereof, of the base station described above in connection with FIG. 2. In some aspects, the communication manager 1304 may include the reception component 1302, the transmission component 1306, and/or the like. In some aspects, the means provided by the communication manager 1304 may include, or be included within means provided by the reception component 1302, the transmission component 1304, and/or the like.

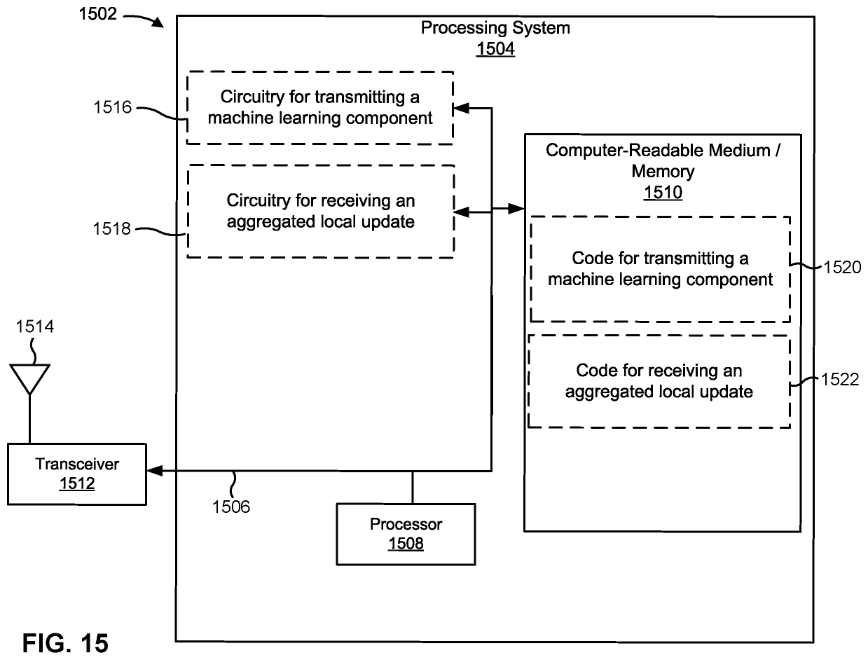

In some aspects, the communication manager 1304 and/or one or more components thereof may include or may be implemented within hardware (e.g., one or more of the circuitry described in connection with FIG. 15). In some aspects, the communication manager 1304 and/or one or more components thereof may include or may be implemented within a controller/processor, a memory, or a combination thereof, of the BS 110 described above in connection with FIG. 2.

In some aspects, the communication manager 1304 and/or one or more components thereof may be implemented in code (e.g., as software or firmware stored in a memory), such as the code described in connection with FIG. 13. For example, the communication manager 1304 and/or a component (or a portion of a component) of the communication manager 1304 may be implemented as instructions or code stored in a non-transitory computer-readable medium and executable by a controller or a processor to perform the functions or operations of the communication manager 1304 and/or the component. If implemented in code, the functions of the communication manager 1304 and/or a component may be executed by a controller/processor, a memory, a scheduler, a communication unit, or a combination thereof, of the BS 110 described above in connection with FIG. 2.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

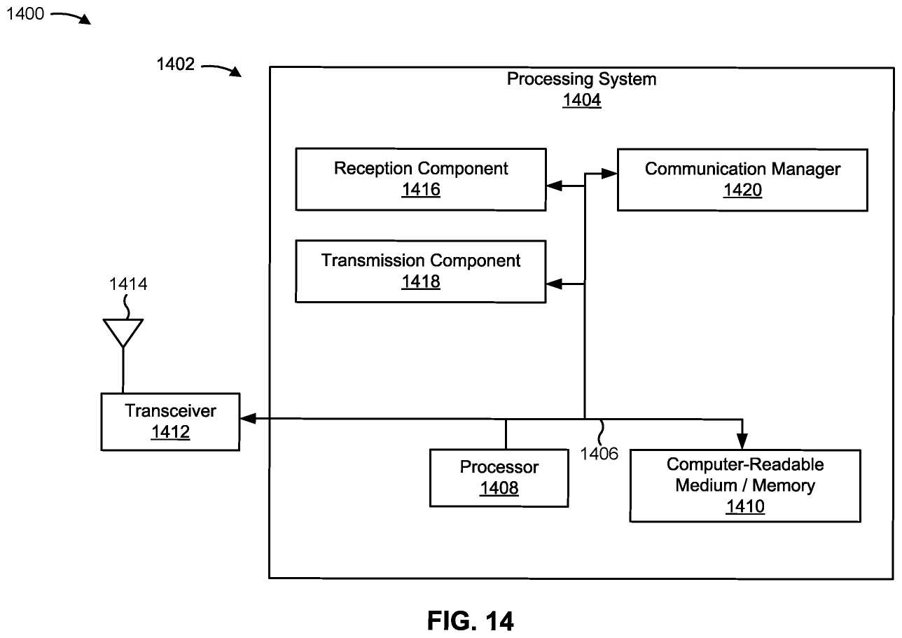

FIG. 14 is a diagram illustrating an example 1400 of a hardware implementation for an apparatus 1402 employing a processing system 1404. The apparatus 1402 may be, be similar to, include, or be included in the apparatus 1300 shown in FIG. 13.

The processing system 1404 may be implemented with a bus architecture, represented generally by the bus 1406. The bus 1406 may include any number of interconnecting buses and bridges depending on the specific application of the processing system 1404 and the overall design constraints. The bus 1406 links together various circuits including one or more processors and/or hardware components, represented by a processor 1408, the illustrated components, and the computer-readable medium/memory 1410. The bus 1406 may also link various other circuits, such as timing sources, peripherals, voltage regulators, power management circuits, and/or the like.

The processing system 1404 may be coupled to a transceiver 1412. The transceiver 1412 is coupled to one or more antennas 1414. The transceiver 1412 provides a means for communicating with various other apparatuses over a transmission medium. The transceiver 1412 receives a signal from the one or more antennas 1414, extracts information from the received signal, and provides the extracted information to the processing system 1404, specifically a reception component 1416. In addition, the transceiver 1412 receives information from the processing system 1404, specifically a transmission component 1418, and generates a signal to be applied to the one or more antennas 1414 based at least in part on the received information.

The processor 1408 is coupled to the computer-readable medium/memory 1410. The processor 1408 is responsible for general processing, including the execution of software stored on the computer-readable medium/memory 1410. The software, when executed by the processor 1408, causes the processing system 1404 to perform the various functions described herein in connection with a server. The computer-readable medium/memory 1410 may also be used for storing data that is manipulated by the processor 1408 when executing software. The processing system 1404 may include any number of additional components not illustrated in FIG. 14. The components illustrated and/or not illustrated may be software modules running in the processor 1408, resident/stored in the computer readable medium/memory 1410, one or more hardware modules coupled to the processor 1408, or some combination thereof.

In some aspects, the processing system 1404 may be a component of the UE 120 and may include the memory 282 and/or at least one of the TX MIMO processor 266, the RX processor 258, and/or the controller/processor 280. In some aspects, the apparatus 1402 for wireless communication provides means for transmitting a federated learning participant indication that identifies a plurality of UEs that are participating in a federated learning round for training a machine learning component; and receiving an aggregated update that is based at least in part on a first local update associated with the machine learning component and a second local update associated with the machine learning component. The aforementioned means may be one or more of the aforementioned components of the processing system 1404 of the apparatus 1402 configured to perform the functions recited by the aforementioned means. As described elsewhere herein, the processing system 1404 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 14 is provided as an example. Other examples may differ from what is described in connection with FIG. 14.

FIG. 15 is a diagram illustrating an example 1500 of an implementation of code and circuitry for an apparatus 1502 for wireless communication. The apparatus 1502 may be, be similar to, include, or be included in the apparatus 1300 shown in FIG. 13, and/or the apparatus 1402 shown in FIG. 14. The apparatus 1502 may include a processing system 1504, which may include a bus 1506 coupling one or more components such as, for example, a processor 1508, computer-readable medium/memory 1510, a transceiver 1512, and/or the like. As shown, the transceiver 1512 may be coupled to one or more antenna 1514.

As further shown in FIG. 15, the apparatus 1502 may include circuitry for transmitting a machine learning component to a set of UEs (circuitry 1516). For example, the apparatus 1502 may include circuitry 1516 to enable the apparatus 1520 to transmit a machine learning component to a set of UEs.

As further shown in FIG. 15, the apparatus 1502 may include circuitry for receiving an aggregated local update that is based at least in part on a first local update associated with the machine learning component and a second local update associated with the machine learning component (circuitry 1518). For example, the apparatus 1502 may include circuitry 1518 to enable the apparatus 1502 to receive an aggregated local update that is based at least in part on a first local update associated with the machine learning component and a second local update associated with the machine learning component.

As further shown in FIG. 15, the apparatus 1502 may include, stored in computer-readable medium 1510, code for transmitting a machine learning component to a set of UEs (code 1520). For example, the apparatus 1502 may include code 1520 that, when executed by the processor 1508, may cause the transceiver 1512 to transmit a machine learning component to a set of UEs.

As further shown in FIG. 15, the apparatus 1502 may include, stored in computer-readable medium 1510, code for receiving an aggregated local update that is based at least in part on a first local update associated with the machine learning component and a second local update associated with the machine learning component (code 1522). For example, the apparatus 1502 may include code 1522 that, when executed by the processor 1508, may cause the transceiver 1512 to receive an aggregated local update that is based at least in part on a first local update associated with the machine learning component and a second local update associated with the machine learning component.

FIG. 15 is provided as an example. Other examples may differ from what is described in connection with FIG. 15.

The following provides an overview of aspects of the present disclosure:

Aspect 1: A method of wireless communication performed by a first user equipment (UE), comprising: receiving a sidelink communication that includes a first local update associated with a machine learning component; and transmitting an aggregated local update based at least in part on the first local update associated with the machine learning component and a second local update associated with the machine learning component.

Aspect 2: The method of aspect 1, further comprising determining the second local update associated with the machine learning component based at least in part on training the machine learning component.

Aspect 3: The method of aspect 1, wherein receiving the sidelink communication that includes the first local update comprises receiving the sidelink communication from a second UE, the method further comprising receiving the second local update from a third UE.

Aspect 4: The method of any of aspects 1-3, further comprising: receiving, from a second UE, a request for local update uploading assistance; and transmitting, to the second UE, an assistance confirmation, wherein receiving the sidelink communication that includes the first local update comprises receiving the first local update based at least in part on transmitting the assistance confirmation.

Aspect 5: The method of aspect 4, wherein the request comprises a request to perform an aggregation of the first local update and the second local update.

Aspect 6: The method of any of aspects 1-5, wherein the first local update comprises compressed first local update information.

Aspect 7: The method of aspect 6, further comprising: compressing second local update information to generate compressed second local update information; and aggregating the compressed first local update information and the compressed second local update information to generate the aggregated local update.

Aspect 8: The method of any of aspects 1-7, further comprising generating the aggregated local update by aggregating the first local update and the second local update, wherein aggregating the first local update and the second local update comprises averaging the first local update and the second local update.

Aspect 9: The method of any of aspects 1-8, wherein transmitting the aggregated local update comprises transmitting the aggregated local update to a base station, the method further comprising transmitting an assistance notification to the base station, wherein the assistance notification indicates that the aggregated local update comprises an aggregation of the first local update and the second local update.

Aspect 10: The method of aspect 9, wherein the assistance notification indicates an identifier associated with a second UE.

Aspect 11: The method of any of aspects 1-8, wherein transmitting the aggregated local update comprises transmitting the aggregated local update to a third UE.

Aspect 12: The method of any of aspects 1-11, wherein the first local update comprises an additional aggregated local update.

Aspect 13: A method of wireless communication performed by a user equipment (UE), comprising: receiving a machine learning component; and transmitting a sidelink communication that includes a first local update associated with the machine learning component to an additional UE.

Aspect 14: The method of aspect 13, further comprising receiving a federated learning participant indication that identifies the additional UE as a UE that is participating in a federated learning round for training the machine learning component.

Aspect 15: The method of either of aspects 13 or 14, further comprising: transmitting, to the additional UE, a request for local update uploading assistance; and receiving, from the additional UE, an assistance confirmation, wherein transmitting the sidelink communication to the additional UE comprises transmitting the sidelink communication based at least in part on receiving the assistance confirmation.

Aspect 16: The method of aspect 15, wherein the request comprises a request to perform an aggregation of the first local update and a second local update, wherein the second local update is generated by the additional UE.

Aspect 17: The method of any of aspects 13-16, wherein the first local update comprises at least one gradient of a loss function associated with the machine learning component.

Aspect 18: The method of any of aspects 13-17, wherein the first local update comprises compressed local update information.

Aspect 19: The method of any of aspects 13-18, further comprising transmitting an assistance notification to a base station, wherein the assistance notification indicates that the first UE is sending the first local update to the additional UE.

Aspect 20: The method of aspect 19, wherein the assistance notification indicates an identifier associated with the additional UE.

Aspect 21: The method of any of aspects 13-20, further comprising: determining that a channel quality associated with an uplink channel fails to satisfy a quality threshold, wherein transmitting the sidelink communication comprises transmitting the sidelink communication based at least in part on determining that the channel quality associated with the uplink channel fails to satisfy a quality threshold.

Aspect 22: A method of wireless communication performed by a base station, comprising: transmitting a machine learning component to a set of user equipment (UEs); and receiving an aggregated local update that is based at least in part on a first local update associated with the machine learning component and a second local update associated with the machine learning component.

Aspect 23: The method of aspect 22, further comprising transmitting a federated learning participant indication that identifies a plurality of UEs, of the set of UEs, that are participating in a federated learning round for training the machine learning component.

Aspect 24: The method of either of aspects 22 or 23, further comprising receiving an assistance notification from a first UE, wherein the assistance notification indicates that the first UE is sending the first local update to the second UE.

Aspect 25: The method of aspect 24, wherein the assistance notification indicates an identifier associated with the second UE.

Aspect 26: The method of any of aspects 22-25, further comprising receiving an assistance notification from a first UE, wherein the assistance notification indicates that the aggregated local update comprises an aggregation of the first local update and the second local update.

Aspect 27: The method of aspect 26, wherein the first local update corresponds to the first UE and the second local update corresponds to the second UE.

Aspect 28: The method of any of aspects 22-27, wherein the assistance notification indicates a first identifier associated with the first UE and a second identifier associated with the second UE.

Aspect 29: The method of any of aspects 22-28, wherein the aggregated local update comprises compressed aggregated local update information.

Aspect 28: An apparatus for wireless communication at a device, comprising a processor; memory coupled with the processor; and instructions stored in the memory and executable by the processor to cause the apparatus to perform the method of one or more aspects of aspects 1-12.

Aspect 29: A device for wireless communication, comprising a memory and one or more processors coupled to the memory, the memory and the one or more processors configured to perform the method of one or more aspects of aspects 1-12.

Aspect 30: An apparatus for wireless communication, comprising at least one means for performing the method of one or more aspects of aspects 1-12.

Aspect 31: A non-transitory computer-readable medium storing code for wireless communication, the code comprising instructions executable by a processor to perform the method of one or more aspects of aspects 1-12.

Aspect 32: A non-transitory computer-readable medium storing a set of instructions for wireless communication, the set of instructions comprising one or more instructions that, when executed by one or more processors of a device, cause the device to perform the method of one or more aspects of aspects 1-12.

Aspect 33: An apparatus for wireless communication at a device, comprising a processor; memory coupled with the processor; and instructions stored in the memory and executable by the processor to cause the apparatus to perform the method of one or more aspects of aspects 13-21.

Aspect 34: A device for wireless communication, comprising a memory and one or more processors coupled to the memory, the memory and the one or more processors configured to perform the method of one or more aspects of aspects 13-21.

Aspect 35: An apparatus for wireless communication, comprising at least one means for performing the method of one or more aspects of aspects 13-21.

Aspect 36: A non-transitory computer-readable medium storing code for wireless communication, the code comprising instructions executable by a processor to perform the method of one or more aspects of aspects 13-21.

Aspect 37: A non-transitory computer-readable medium storing a set of instructions for wireless communication, the set of instructions comprising one or more instructions that, when executed by one or more processors of a device, cause the device to perform the method of one or more aspects of aspects 13-21.

Aspect 38: An apparatus for wireless communication at a device, comprising a processor; memory coupled with the processor; and instructions stored in the memory and executable by the processor to cause the apparatus to perform the method of one or more aspects of aspects 22-29.

Aspect 39: A device for wireless communication, comprising a memory and one or more processors coupled to the memory, the memory and the one or more processors configured to perform the method of one or more aspects of aspects 22-29.

Aspect 40: An apparatus for wireless communication, comprising at least one means for performing the method of one or more aspects of aspects 22-29.

Aspect 41: A non-transitory computer-readable medium storing code for wireless communication, the code comprising instructions executable by a processor to perform the method of one or more aspects of aspects 22-29.

Aspect 42: A non-transitory computer-readable medium storing a set of instructions for wireless communication, the set of instructions comprising one or more instructions that, when executed by one or more processors of a device, cause the device to perform the method of one or more aspects of aspects 22-29.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors coupled to the memory, the memory and the one or more processors configured to:
receive a sidelink communication that includes a first local update associated with a machine learning component; and
transmit an aggregated local update based at least in part on the first local update associated with the machine learning component and a second local update associated with the machine learning component.

2. The first UE of claim 1, wherein the memory and the one or more processors are further configured to determine the second local update associated with the machine learning component based at least in part on training the machine learning component.

3. The first UE of claim 1, wherein the memory and the one or more processors, when receiving the sidelink communication, are configured to receive the sidelink communication from a second UE, and wherein the memory and the one or more processors are further configured to receive the second local update from a third UE.

4. The first UE of claim 1, wherein the memory and the one or more processors are further configured to:
receive, from a second UE, a request for local update uploading assistance; and
transmit, to the second UE, an assistance confirmation, wherein the memory and the one or more processors, when receiving the sidelink communication, are configured to receive the first local update based at least in part on transmitting the assistance confirmation.

5. The first UE of claim 4, wherein the request comprises a request to perform an aggregation of the first local update and the second local update.

6. The first UE of claim 1, wherein the first local update comprises compressed first local update information.

7. The first UE of claim 6, wherein the memory and the one or more processors are further configured to:
compress second local update information to generate compressed second local update information; and
aggregate the compressed first local update information and the compressed second local update information to generate the aggregated local update.

8. The first UE of claim 1, wherein the memory and the one or more processors are further configured to generate the aggregated local update by aggregating the first local update and the second local update, wherein the memory and the one or more processors are configured to aggregate the first local and the second local update by averaging the first local update and the second local update.

9. The first UE of claim 1, further comprising a transceiver, wherein the memory and the one or more processors, when transmitting the aggregated local update, are further configured to transmit, using the transceiver, the aggregated local update to a base station, and wherein the memory and the one or more processors are further configured to transmit, using the transceiver, an assistance notification to the base station, wherein the assistance notification indicates that the aggregated local update comprises an aggregation of the first local update and the second local update.

10. The first UE of claim 9, wherein the assistance notification indicates an identifier associated with a second UE.

11. The first UE of claim 1, wherein the memory and the one or more processors, when transmitting the aggregated local update, are configured to transmit the aggregated local update to a third UE.

12. The first UE of claim 1, wherein the first local update comprises an additional aggregated local update.

13. A user equipment (UE) for wireless communication, comprising:
a memory; and
one or more processors coupled to the memory, the memory and the one or more processors configured to:
receive a machine learning component; and
transmit a sidelink communication that includes a first local update associated with the machine learning component to an additional UE.

14. The UE of claim 13, further comprising a transceiver, wherein the memory and the one or more processors are further configured to receive, using the transceiver, a federated learning participant indication that identifies the additional UE as a UE that is participating in a federated learning round for training the machine learning component.

15. The UE of claim 13, wherein the memory and the one or more processors are further configured to:
transmit, to the additional UE, a request for local update uploading assistance; and
receive, from the additional UE, an assistance confirmation, wherein the memory and the one or more processors, when transmitting the sidelink communication to the additional UE are further configured to transmit the sidelink communication based at least in part on receiving the assistance confirmation.

16. The UE of claim 15, wherein the request comprises a request to perform an aggregation of the first local update and a second local update, wherein the second local update is generated by the additional UE.

17. The UE of claim 13, wherein the first local update comprises at least one gradient of a loss function associated with the machine learning component.

18. The UE of claim 13, wherein the first local update comprises compressed local update information.

19. The UE of claim 13, wherein the memory and the one or more processors are further configured to transmit an assistance notification to a base station, wherein the assistance notification indicates that the UE is sending the first local update to the additional UE.

20. The UE of claim 19, wherein the assistance notification indicates an identifier associated with the additional UE.

21. The UE of claim 13, wherein the memory and the one or more processors are further configured to:
determine that a channel quality associated with an uplink channel fails to satisfy a quality threshold,
wherein the memory and the one or more processors, when transmitting the sidelink communication, are configured to transmit the sidelink communication based at least in part on determining that the channel quality associated with the uplink channel fails to satisfy a quality threshold.

22. A base station for wireless communication, comprising:
a memory; and
one or more processors coupled to the memory, the memory and the one or more processors configured to:
transmit a machine learning component to a set of user equipment (UEs); and
receive an aggregated local update that is based at least in part on a first local update associated with the machine learning component and a second local update associated with the machine learning component.

23. The base station of claim 22, wherein the memory and the one or more processors are further configured to transmit a federated learning participant indication that identifies a plurality of UEs, of the set of UEs, that are participating in a federated learning round for training the machine learning component.

24. The base station of claim 22, wherein the memory and the one or more processors are further configured to receive an assistance notification from a first UE, wherein the assistance notification indicates that the first UE is sending the first local update to the second UE.

25. The base station of claim 24, wherein the assistance notification indicates an identifier associated with the second UE.

26. The base station of claim 22, wherein the memory and the one or more processors are further configured to receive an assistance notification from a second UE, wherein the assistance notification indicates that the aggregated local update comprises an aggregation of the first local update and the second local update.

27. The base station of claim 26, wherein the first local update corresponds to the first UE and the second local update corresponds to the second UE.

28. The base station of claim 26, wherein the assistance notification indicates a first identifier associated with the first UE and a second identifier associated with the second UE.

29. The base station of claim 22, wherein the aggregated local update comprises compressed aggregated local update information.

30. A method of wireless communication performed by a first user equipment (UE), comprising:
receiving a sidelink communication that includes a first local update associated with a machine learning component; and
transmitting an aggregated local update based at least in part on the first local update associated with the machine learning component and a second local update associated with the machine learning component.
